(19) United States
(12) Patent Application Publication
(10) Pub. No.: US 2006/0099352 A1
(43) Pub. Date: May 11, 2006

(54) Coating method using synthetic resin including nano-silver powder via ultrasonic waves

(75) Inventor: Hyun-Dae Sun, Hwaseong-si (KR)

Correspondence Address: STEIN, MCEWEN & BUI, LLP, 1400 EYE STREET, NW, SUITE 300, WASHINGTON, DC, 20005, US

(73) Assignee: DOOIL Co., Ltd., Hwaseong-si (KR)

(21) Appl. No.: 11/028,589

(22) Filed: Jan. 5, 2005

(30) Foreign Application Priority Data
Nov. 9, 2004 (KR) 2004-90651

(51) Int. Cl. B05D 1/12

(52) U.S. Cl. 427/600; 427/180

(57) ABSTRACT

Disclosed herein is a coating method using a synthetic resin including nano-silver powder via ultrasonic waves, including mixing nano-silver powder and a synthetic resin using an ultrasonic distributor, to prepare a mixture, which is then periodically pumped and coated onto a predetermined target. In the application method of the current invention, the mixing process by ultrasonic dispersion does not crush the nano-silver particles, and thus, the unique properties of nano-silver can be maximally exhibited after application. Further, in cases where the mixture is used over a long time or is intermittently used, precipitation of the nano-silver particles due to a difference in specific gravity between the nano-silver and the synthetic resin can be prevented by periodically cycling the mixture using a cycling pump. Furthermore, the long time required for the mixing process can be reduced by diluting the above mixture with 5 times the amount of the same synthetic resin as the synthetic resin used in the mixture.

### BACKGROUND OF THE INVENTION

1. Field of the Invention

The present invention relates, in general, to a coating method using a synthetic resin including nano-silver powder via ultrasonic waves, and, more specifically, to a method of applying a synthetic resin including nano-silver powder in which the mixing of the nano-silver powder and the synthetic resin is performed by an ultrasonic dispersion process.

2. Description of the Related Art

With great advances in industrialization, people are increasingly interested in their health.

Silver, which has value as a precious metal, is environmentally friendly, and has no toxicity when a small amount thereof is used, and also, can exhibit various properties, such as antibacterial, sterilizing, antifungal, deodorizing, far infrared ray emission and electromagnetic shielding properties, which may persist for a long period. Thus, silver is regarded to be beneficial to human beings and the environment.

In recent years, silver, having the above properties, has been used in appliances, and cosmetic and flooring products.

As such, silver is applied according to two methods, one in which silver powder is included in the product, the other in which it is applied on a surface of the product.

In cases where silver is included in the product, since the silver component is not exposed externally, it is difficult to manifest the desirable functions of silver. Therefore, it is preferable that silver be applied on the product.

In this regard, a method of applying silver on products is disclosed in Korean Patent Laid-open Publication No. 2003-0036490, in which a film composition comprising hot melt polyurethane and nano-sized or micro-sized silver particles is provided. The composition has 70-98 wt % hot melt polyurethane and 20-200 ppm silver particle colloid. When this composition is applied on a product, it can exhibit environmentally friendly properties and is harmless to human beings. However, upon adding the nano-silver powder to polyurethane, it is difficult to form a uniform mixture. Hence, the above invention is disadvantageous because the silver component in the composition cannot be uniformly distributed on the coated product.

Likewise, Korean Patent Laid-open Publication No. 2002-0028026 discloses an improvement of a process of mixing an organic silicon compound, a filler, and a solvent using an ultrasonic dispersion technique. However, the above patent has the disadvantages of precipitation of the organic silicon compound due to a difference in specific gravity between the organic silicon compound and the solvent, and the use of the additional filler to achieve uniform mixing of the organic silicon compound and the solvent.

### SUMMARY OF THE INVENTION

Accordingly, the present invention has been made keeping in mind the above problems occurring in the related art, and an object of the present invention is to provide a coating method using a synthetic resin including nano-silver powder via ultrasonic waves, in which the nano-silver powder is mixed with the synthetic resin so as not to crush the nano-silver particles.

Another object of the present invention is to provide a coating method using a synthetic resin including nano-silver powder via ultrasonic waves, in which the nano-silver particles having higher specific gravity than the synthetic resin are prevented from precipitating out of the mixture of nano-silver and synthetic resin.

A further object of the present invention is to provide a coating method using a synthetic resin including nano-silver powder via ultrasonic waves, in which the time required to mix the nano-silver and the synthetic resin is reduced through a dilution process.

In order to accomplish the above objects, the present invention provides a coating method using a synthetic resin including nano-silver powder via ultrasonic waves, comprising: mixing nano-silver powder and a synthetic resin using an ultrasonic distributor, to prepare a mixture; periodically pumping the mixture to prevent precipitation of the nano-silver powder out of the mixture due to the difference in specific gravity between the nano-silver powder and the synthetic resin; and applying the pumped mixture onto a predetermined target.

In the coating method of the present invention, the nano-silver powder and the synthetic resin are mixed at a weight ratio of 1:500.

Also, the coating method of the present invention further comprises diluting the mixture with the same synthetic resin as the synthetic resin used in the mixture, in an amount 5 times greater than the amount of the mixture.

Further, the synthetic resin in the mixture has a concentration of 30-35 wt %.

Furthermore, the synthetic resin comprises a thermoplastic resin selected from among acryl, vinyl, PVC, and a UV coating solution.

### DESCRIPTION OF THE PREFERRED EMBODIMENTS

According to a preferred embodiment of the present invention, tiles are coated by mixing nano-silver powder and a synthetic resin using an ultrasonic distributor to obtain an ultrasonically dispersed mixture, periodically pumping the mixture to prevent precipitation of the nano-silver powder, and loading the pumped mixture into a T-die, followed by applying the mixture on a surface of the tiles using a pair of compressive rollers.

The nano-silver is available from NT Base Co. Ltd., Korea, and has a fine size of 50 nm or less. The properties thereof are summarized in Table 1, below.

TABLE 1
Properties of Nano-Silver

| Properties | |
|---|---|
| Size | 50 nm or less |
| Solubility | No |
| Boiling Point | 2,210° C. |
| Melting Point | 961° C. |
| Explosivity, Oxidativity | No |
| Specific Gravity | 10.49 |
| Purity | 99.99% |

As the synthetic resin, a thermoplastic resin is mainly used, and is selected from among acryl, vinyl, PVC, and a UV coating solution. The synthetic resin in the mixture has a concentration of 30-35 wt %. If the concentration is less than 30 wt %, the viscosity is too low and the synthetic resin may be easily separated from the tile. Meanwhile, if the concentration is higher than 35 wt %, it is difficult to perform the coating process on the tile due to very high viscosity.

The mixing process of the nano-silver powder and the synthetic resin using the ultrasonic distributor according to the present invention does not crush the nano-silver particles, unlike a conventional method of physically mixing nano-silver particles and a synthetic resin. Thus, the unique functions of the nano-silver powder are retained.

Moreover, to prevent the precipitation of the nano-silver powder due to the difference in specific gravity between the nano-silver and the synthetic resin upon formation of the mixture, it is preferable that the mixture be periodically cycled using a pump for a predetermined time.

Then, the mixture of nano-silver and synthetic resin obtained by ultrasonic dispersion is applied on the surface of the tiles, thereby manifesting the electrostatic decay, electromagnetic shielding, surface sterilization, and antibacterial and deodorizing properties.

The tile on which nano-silver is applied is measured for surface electric resistance, which is found to be 10³-10¹¹ Ω/cm². From this result, it can be confirmed that the nano-silver application exhibits antistactic properties.

Further, with the aim of reducing the time required for the mixing process, the synthetic resin and the nano-silver are primarily mixed at a weight ratio of 500:1 by ultrasonic dispersion, to prepare the mixture. Subsequently, the above mixture is diluted with the same synthetic resin as the synthetic resin used in the mixture, in an amount 5 times greater than the amount of the mixture of resin and nano-silver, before the pumping process.

Hence, it is preferable that the mixing ratio by weight of the nano-silver to the synthetic resin be 1:2500. In the present invention, mixing by ultrasonic dispersion is advantageous because the nano-silver particles can be uniformly added to the synthetic resin without being crushed. Thereby, the application of such a mixture on the tiles manifests the unique functions of nano-silver.

In this way, although the coating method of the present invention is applied to the tiles, it may be employed to UV coating, PVC top coating, flooring covered with laminated paper, wallpaper, clothes, fabrics, PU, PP, ABS, wood (MDF), HDF, packaging paper, transfer paper, fabric transfer, interior film sheet, plastics, etc.

As described above, the present invention provides a method of applying a synthetic resin including nano-silver using ultrasonic waves. In the method of the present invention, since the mixing process of the synthetic resin and the nano-silver is performed using the ultrasonic distributor, the crush of the nano-silver particles is prevented. Thus, when the above mixture is coated on a desired target, the unique functions of the nano-silver can be maximally exhibited. Further, in cases where the application process takes a long time, the nano-silver particles may precipitate due to the difference in specific gravity between the synthetic resin and the nano-silver. Accordingly, the mixture is periodically cycled using a cycling pump, thereby preventing the precipitation of the nano-silver. Furthermore, the mixing process of the synthetic resin and the nano-silver particles requires a considerably long time. Hence, the resin and the nano-silver are primarily mixed using the ultrasonic distributor, after which the above mixture is diluted with the same synthetic resin as the synthetic resin used in the mixture in an amount 5 times greater than the amount of the mixture. Thereby, the time required for the ultrasonic dispersion treatment can be reduced.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A coating method using a synthetic resin including nano-silver powder via ultrasonic waves, comprising:
mixing nano-silver powder and a synthetic resin using an ultrasonic distributor, to prepare a mixture;
periodically pumping the mixture to prevent precipitation of the nano-silver powder out of the mixture due to a difference in specific gravity between the nano-silver powder and the synthetic resin; and
applying the pumped mixture onto a predetermined target.

2. The method as set forth in claim 1, wherein the nano-silver powder and the synthetic resin are mixed at a weight ratio of 1:500.

3. The method as set forth in claim 2, further comprising diluting the mixture with a same synthetic resin as the synthetic resin used in the mixture, in an amount 5 times greater than the amount of the mixture, before the pumping.

4. The method as set forth in claim 1, wherein the synthetic resin in the mixture has a concentration of 30-35 wt %.

5. The method as set forth in claim 1, wherein the synthetic resin comprises a thermoplastic resin selected from among acryl, vinyl, PVC, and a UV coating solution.

6. The method as set forth in claim 2, wherein the synthetic resin comprises a thermoplastic resin selected from among acryl, vinyl, PVC, and a UV coating solution.

7. The method as set forth in claim 3, wherein the synthetic resin comprises a thermoplastic resin selected from among acryl, vinyl, PVC, and a UV coating solution.

8. The method as set forth in claim 4, wherein the synthetic resin comprises a thermoplastic resin selected from among acryl, vinyl, PVC, and a UV coating solution.
